(19) United States
(12) Patent Application Publication
(10) Pub. No.: US 2014/0340329 A1
(43) Pub. Date: Nov. 20, 2014

(54) Touch Controlled Screen Apparatus

(71) Applicants: MiTAC Research (Shanghai) Ltd., Shanghai (CN); MiTAC International Corp., Kuei San Township (TW)

(72) Inventor: Xin Chen, Shanghai (CN)

(73) Assignees: MiTAC Research (Shanghai) Ltd., Shanghai (CN); MiTAC International Corp., Kuei San Township (TW)

(21) Appl. No.: 14/206,989

(22) Filed: Mar. 12, 2014

(30) Foreign Application Priority Data
May 17, 2013 (CN) 201310186517.X

(51) Int. Cl. G06F 3/041

(52) U.S. Cl. CPC G06F 3/0416
USPC 345/173

(57) ABSTRACT

A touch controlled screen apparatus which includes a storage module, a touch controlled display module and a processing module. The storage module stores at least one predetermined icon program, and the predetermined icon program has a graphic interface. The touch controlled display module displays the graphic interface and detects a touch contact or a touch track to generate a touch signal. When the processing module receives an execution signal at a first status of the touch controlled screen apparatus, the processing module executes the at least one predetermined icon program, and generates an operation signal according to touch signal corresponding to operation on the graphic interface. When the processing module determines that the operation signal matches a predetermined condition, the processing module closes the at least one predetermined icon program, and controls the touch controlled screen apparatus to change to a second status from the first status.

### CROSS-REFERENCE TO RELATED APPLICATION

This application claims the benefit of China Patent Application No. 201310186517.X, filed on May 17, 2013, in the State Intellectual Property Office of the People's Republic of China, the disclosure of which is incorporated herein in its entirety by reference.

### BACKGROUND OF THE INVENTION

1. Field of the Invention

The present invention generally relates to a touch controlled screen apparatus, and particularly to a touch controlled screen apparatus capable of performing a touch operation in a game icon program for releasing the lock mode of electronic apparatus.

2. Description of the Related Art

The touch controlled screen technology improves and becomes mature while the technology is greatly developed, the present products with touch controlled screens, such as Tablet PC, touch controlled mobile phone, and touch controlled navigation apparatus and so on, gradually become mainstream products instead of traditional products. The touch controlled manner mainly replaces the traditional physical keyboard structure with way of touching words or figures displayed on the touch controlled LCD screen. By applying this technology, users can touch the screen by their fingers to implement data input and control, and thereby make human-machine interface operation more direct, and the advantage of more convenient operation can be achieved.

When electronic apparatus, such as Tablet PC, touch controlled mobile phone, or Personal Digital Assistant (PDA), is in standby for a period of time, the touch controlled screens of electronic apparatuses will enter a sleep mode or a lock mode for preventing from user's or other's inadvertent touch and saving unnecessary power consumption. Then, if user wants to use electronic apparatus to execute one function, the touch controlled screen must be unlocked first, and then user can begin to operate the electronic apparatus.

Currently, there are many traditional manners of unlocking touch controlled screen, for example, the touch controlled screen can be unlocked and turned on by sliding horizontally, sliding vertically, sliding in particular track or inputting particular password on the touch controlled screen. However, unlock operation of aforementioned unlock manner and unlock condition is very unexciting.

### SUMMARY OF THE INVENTION

In view of problems in prior art, one objective of the present invention is to provide a touch controlled screen apparatus, to solve the problem that the unlock manner in prior art is very unexciting.

To achieve the foregoing objective, the present invention provides a touch controlled screen apparatus comprising a storage module, a touch controlled display module and a processing module. The storage module stores at least one predetermined icon program, and the at least one predetermined icon program has a graphic interface. The touch controlled display module displays the graphic interface and detects a touch contact or a touch track to generate a touch signal. The processing module is electrically connected to the storage module and the touch controlled display module and receives the touch signal. When the processing module receives an execution signal at a first status of the touch controlled screen apparatus, the processing module executes the at least one predetermined icon program, and generates an operation signal according to touch signal corresponding to operation on the graphic interface. When the processing module determines that the operation signal matches a predetermined condition, the processing module closes the at least one predetermined icon program, and control the touch controlled screen apparatus to change to a second status from the first status.

Preferably, the graphic interface comprises an active object, and when the touch signal corresponding to the touch track is generated, the processing module determines a movement track of the active object according to the operation signal corresponding to the touch signal.

Preferably, the graphic interface further comprises a passive object, when the processing module control the active object to move along the movement track, and when the active object is moved to the passive object, the processing module determines that the operation signal matches the predetermined condition.

Preferably, the graphic interface comprises an active object, and when the touch signal corresponding to the touch is generated, the processing module determines a movement direction of the active object according to the operation signal corresponding to the touch signal.

Preferably, the graphic interface further comprises a passive object, when the touch is removed by the touch controlled display module, the processing module controls the active object to move along the movement direction; and the processing module determines that the operation signal matches the predetermined condition when the active object is moved to the passive object.

Preferably, the passive object may have at least two target areas, and when the active object is moved to one of at least two target areas corresponding to a predetermined area, the processing module determines that the operation signal matches the predetermined condition.

Preferably, each of at least two target areas respectively has a predetermined score, when the active object is moved to one of the at least two target areas and the processing module determines that the predetermined score exceeds a threshold, the processing module determines that the operation signal matches the predetermined condition.

Preferably, when the processing module does not receive the touch signal for a predetermined period and a count of resetting the predetermined period exceeds a predetermined number, the processing module closes the at least one predetermined icon program.

Preferably, when the processing module determines that an initial touch position of the touch contact or touch track is located at or near the active object, the processing module determines the movement direction or the movement track of the active object according to the operation signal.

In summary, the touch controlled screen apparatus of the present invention may have one or more following advantages:

(1) This touch controlled screen apparatus can allow user to play the game icon program for touch controlled operation, so as to remove the lock mode of the electronic apparatus, thereby interest of operation of the touch controlled screen apparatus may be increased.

(2) The touch controlled screen apparatus may allow user to preset the threshold as particular value or particular range to provide another password setting manner, thereby solving the problem that user cannot perform unlock because of forgetting the particular password and must send the electronic apparatus for repair, and secret keeping effect same as prior art can also be achieved.

### BRIEF DESCRIPTION OF THE DRAWINGS

FIG. 1 is a structure block diagram of a first embodiment of a touch controlled screen apparatus according to the present invention.

FIG. 2 is a first schematic view of the first embodiment of the touch controlled screen apparatus according to the present invention.

FIG. 3 is a second schematic view of the first embodiment of the touch controlled screen apparatus according to the present invention.

FIG. 4 is a third schematic view of the first embodiment of the touch controlled screen apparatus according to the present invention.

FIG. 5 is a fourth schematic view of the first embodiment of the touch controlled screen apparatus according to the present invention.

FIG. 6 is a first schematic view of a second embodiment of the touch controlled screen apparatus according to the present invention.

FIG. 7 is a second schematic view of the second embodiment of the touch controlled screen apparatus according to the present invention.

FIG. 8 is a third schematic view of the second embodiment of the touch controlled screen apparatus according to the present invention.

FIG. 9 is a flow diagram of an unlock method of the touch controlled screen apparatus according to the present invention.

### DETAILED DESCRIPTION OF THE PREFERRED EMBODIMENTS

The technical content of the present invention will become apparent by the detailed description of the following embodiments and the illustration of related drawings as follows. Components that perform the same or similar functions are represented by the same reference numerals on the drawings.

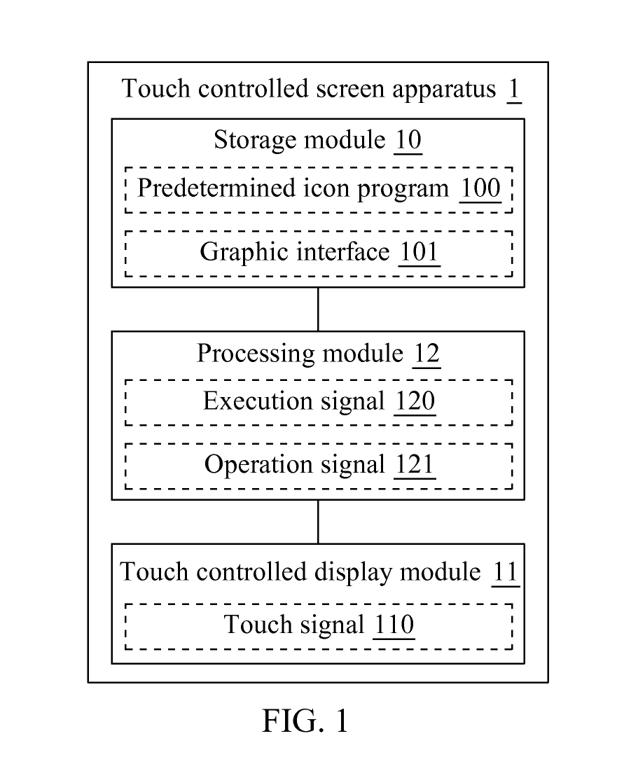

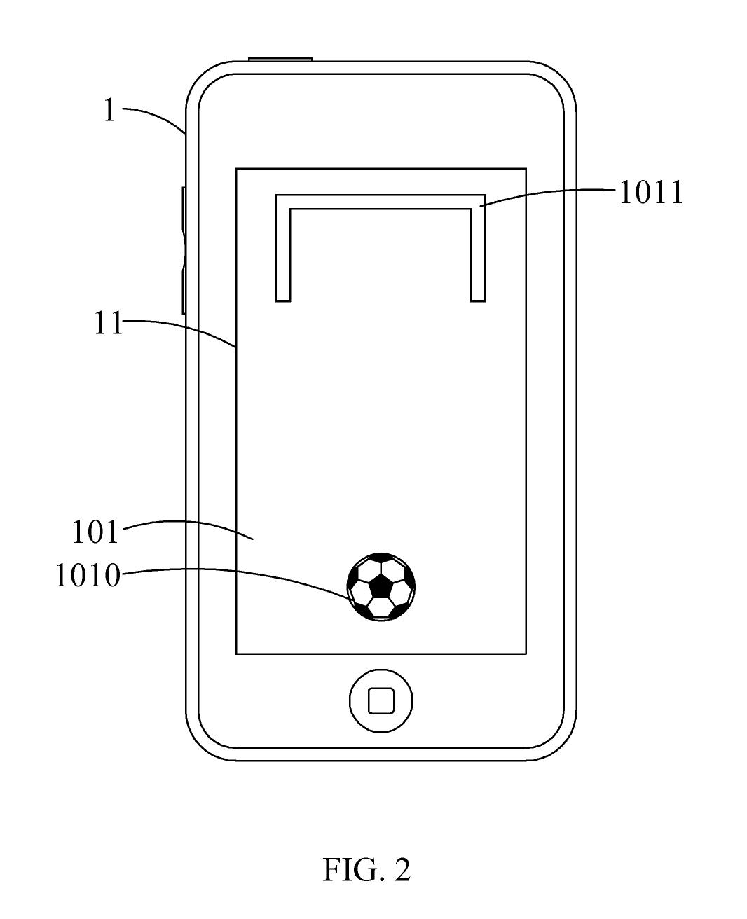

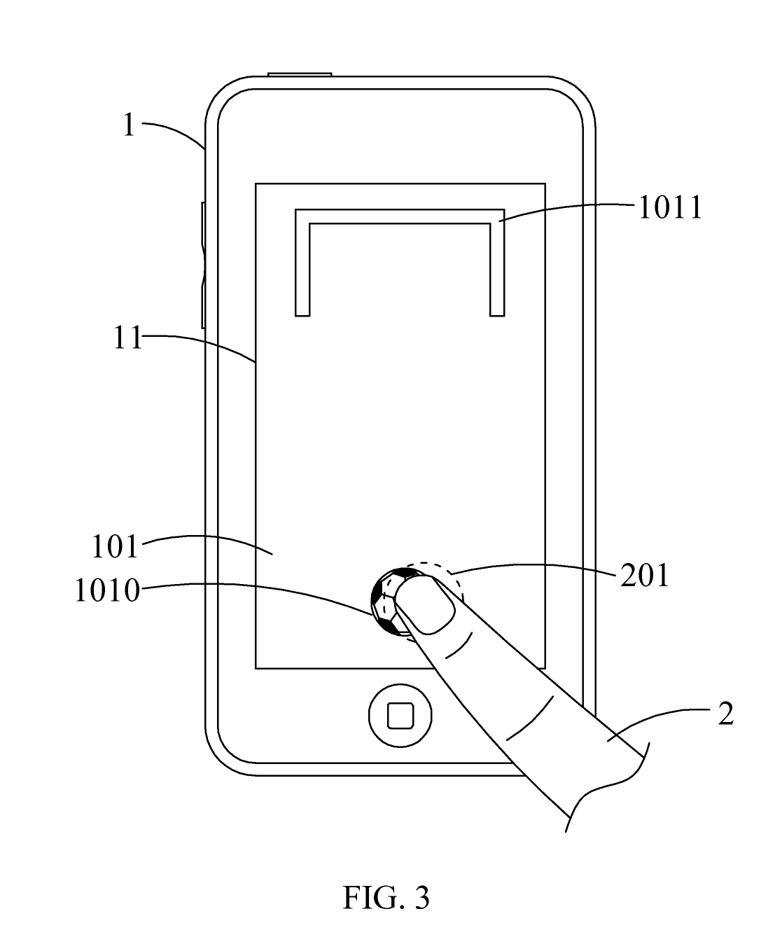

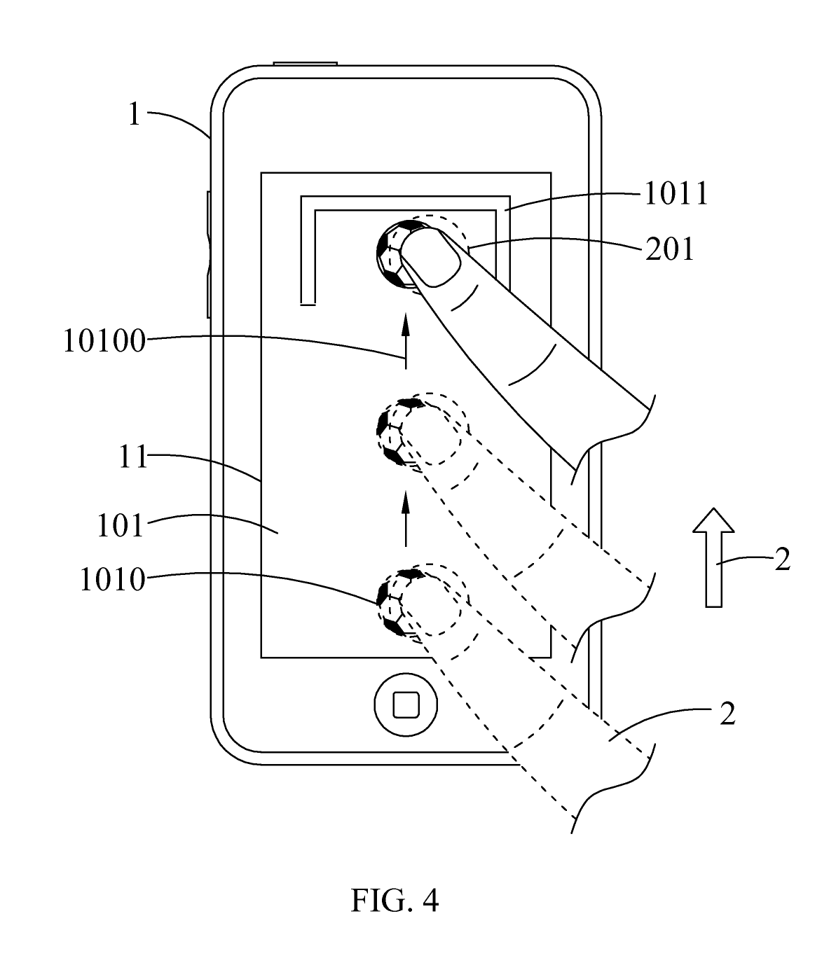

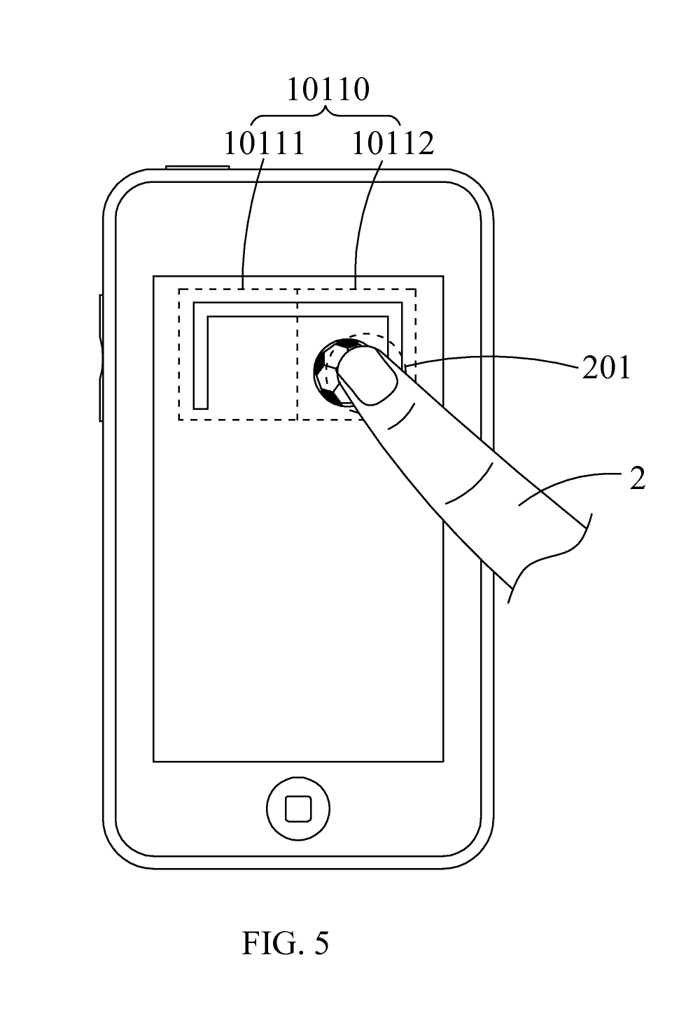

Please refer to FIG. 1 through FIG. 5, FIG. 1 through FIG. 5 are respectively a structure block diagram, and a first schematic view through a fourth schematic view of a first embodiment of a touch controlled screen apparatus according to the present invention. As shown in FIG. 1, a touch controlled screen apparatus 1 comprises a storage module 10, a touch controlled display module 11 and a processing module 12. The touch controlled screen apparatus may be an electronic apparatus, such as Tablet PC, touch controlled mobile phone, PDA (Personal Digital Assistant). The storage module 10 stores at least one predetermined icon program 100, and the at least one predetermined icon program 100 has a graphic interface 101. The touch controlled display module 11 displays the graphic interface 101 and detects a touch contact or a touch track to generate a touch signal 110. The processing module 12 is electrically connected to the storage module 10 and the touch controlled display module 11, and receives the touch signal 110. When the processing module 12 receives an execution signal 120 at the first status of touch controlled screen apparatus 1, the processing module 12 executes at least one predetermined icon program 100, and executes operation of touch signal 110 according to the graphic interface 101, and then generates an operation signal 121. When the processing module 12 determines that the operation signal 121 matches a predetermined condition, the processing module 12 closes the at least one predetermined icon program 100, and controls the touch controlled screen apparatus 1 to change to a second status from the first status. That is, the touch controlled screen apparatus 1 can enter an operation status from a sleep status or a lock status by above described method.

In above description, the graphic interface 101 may comprise preferably an active object 1010; when the touch signal 110 corresponding to the touch track 20 is generated, the processing module 12 determines a movement track 10100 of the active object 1010 according to the operation signal 121 corresponding to the touch signal 110. Preferably, the graphic interface 101 further can comprise a passive object 1011. When the processing module 12 controls the active object 1010 to move along the movement track 10100, the processing module 12 determines that the operation signal matches the predetermined condition while the active object 1010 is moved to where the passive object 1011 is located.

For example, user 2 operates the touch controlled screen apparatus 1 according to the present invention, and the touch controlled screen apparatus 1 will enter the first status as a sleep status or a lock status if being placed without operating and in standby for a period of time. In this embodiment, the first status is the lock status as an example. Next, when user 2 wants to use the touch controlled screen apparatus, user 2 will try to wake the touch controlled screen apparatus 1 first, for example, by ways of pressing the power button or other operation button of the touch controlled screen apparatus 1. At the time, after the processing module 12 receives the execution signal 120 generated upon user's waking operation on touch controlled screen apparatus 1, the processing module will execute the predetermined icon program 100, and control the touch controlled display module 12 to display the graphic interface 101 corresponding to the predetermined icon program 100. Preferably, the predetermined icon program 100 may be various game programs, such as sport game or mind game. In the embodiment, the sport game is taken as example, and the corresponding graphic interface may be icon of a football field, a basketball court or an archery place, and the football field is taken as example.

Meanwhile, the touch controlled display module 11 also displays the active object 1010 and the passive object 1011 in the graphic interface 101. The displayed icons for the active object 1010 and the passive object 1011 can depend on type of the graphic interface 101, if the graphic interface 101 displays a football field, the active object 1010 may be a football or a football player, and the passive object 1011 may be a football goal. After the graphic interface 101 is displayed on the touch controlled display module 11, the user 2 can start to operate the touch controlled display module 11. If the operation matches the predetermined condition, the processing module 12 closes the predetermined icon program 100 such that the touch controlled screen apparatus 1 will change to the second status from the first status. The second status may be a unlock status.

In other words, user 2 can perform a touch contact 201 on the active object 1010 of graphic interface 101 displayed on the touch controlled display module 11 first, and then slide the active object 1010 forward. At the time, the touch controlled display module 11 receives the touch track 20 generated upon the forward slide by user 2, and then generates the touch signal 110 to be transmitted to the processing module 12 according to the touch track 20. The processing module 12 generates the operation signal 121 according to the touch signal 110, and determines that the movement track 10100 of the active object 1010 is forward movement according to the operation signal 121.

Next, the processing module 12 controls the active object 1010 to move forward according to the operation signal 121 corresponding to user's operation. At the time, the processing module 12 determines whether the operation signal 121 corresponding to user's operation matches the predetermined condition. The predetermined condition may be set as the case that football is placed within football goal. Therefore, when user 2 performs operation of the touch track 20 on the touch controlled display module 11, the processing module 12 controls the active object to move along the touch track 20 to the passive object 1011, for example, ball enters football goal, so the processing module 12 determines that the predetermined condition is matched, and then closes the predetermined icon program 100 and makes the touch controlled screen apparatus 1 change to the second status from the first status. The second status may be the unlock status.

In addition, if the passive object 1011 is a football goal, the football goal can be divided into at least two target areas 10110, for example, a left target area 10111 and a right target area 10112 divided by the center of the football goal. The user 2 may set one of the target areas as the predetermined area, and the processing module 12 determines that the predetermined condition is matched only when the active object 1010 is moved to the predetermined area. For example, when user 2 sets the left target area 10111 as the predetermined area, even if the active object 1010 is moved to right target area 10112 within football goal, the predetermined condition is not matched, and the processing module 12 will require user 2 to perform operation afresh. The predetermined condition is not matched and unlock is not performed until user 2 moves the active object 1010 to left side of football goal.

Moreover, each of at least two target areas 10110 may have predetermined score respectively, the predetermined score may be a value, therefore, when user 2 slides the active object 1010 to the target area 10110 on the graphic interface, the processing module 12 determines whether the predetermined score generated upon the operation signal 121 corresponding to user's operation exceeds a threshold, for example, if the predetermined threshold is score 4 and user 2 slides the active object 1010 to the target area 10110 to gain score 5, then the processing module 12 determines whether score 5 exceeds the threshold. If yes, the processing module 12 determines that the operation signal 121 matches the predetermined condition. If no, the processing module 12 determines that the operation signal 121 corresponding to user's operation does not match the predetermined condition and renews the icon program.

In some embodiments, user 2 also can set the threshold as a particular value or a particular range in advance as another password setting manner, such as value 10 or a range of 20 to 50. Therefore, when other person except user 2 tries to operate the touch controlled screen apparatus 1, if the other person moves the active object to one target area, and the gained score for this target area is not equal to said particular value 10 or not within the particular range of 20 to 50, the processing module 12 can determine that the operation signal does not match the predetermined condition, and then require the person to perform operation afresh.

Therefore, user can set the password by using the above mentioned method without setting a particular number as password in the prior art, thereby preventing from the problem that user cannot perform unlock because of forgetting the particular password and must send the electronic apparatus for repair, and secret keeping effect the same as prior art can also be achieved.

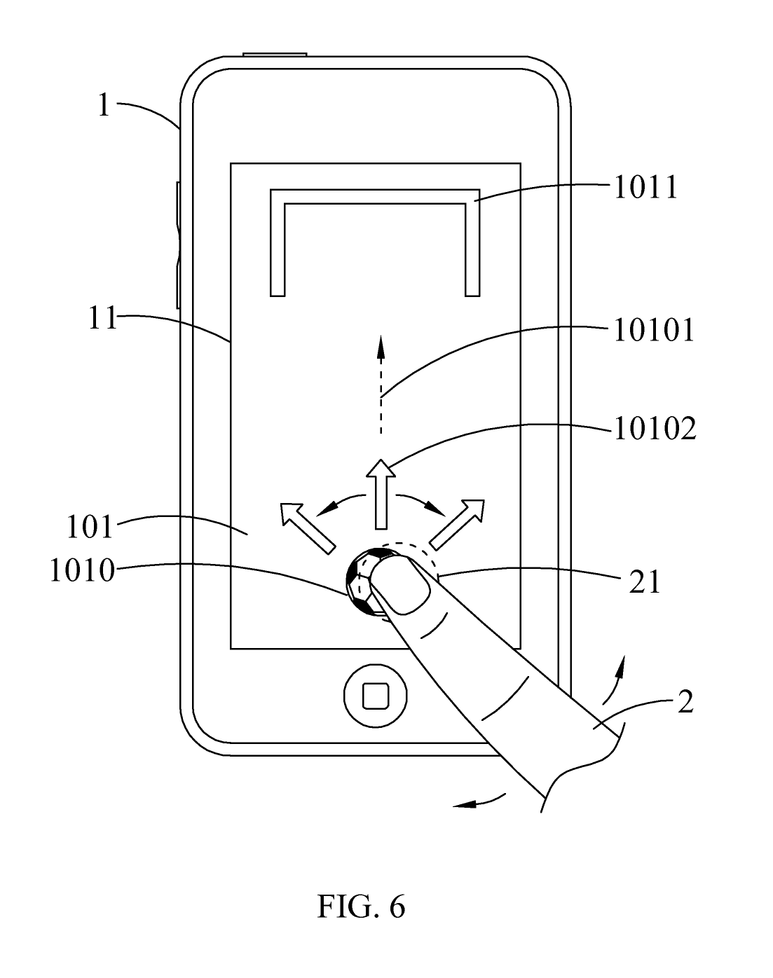

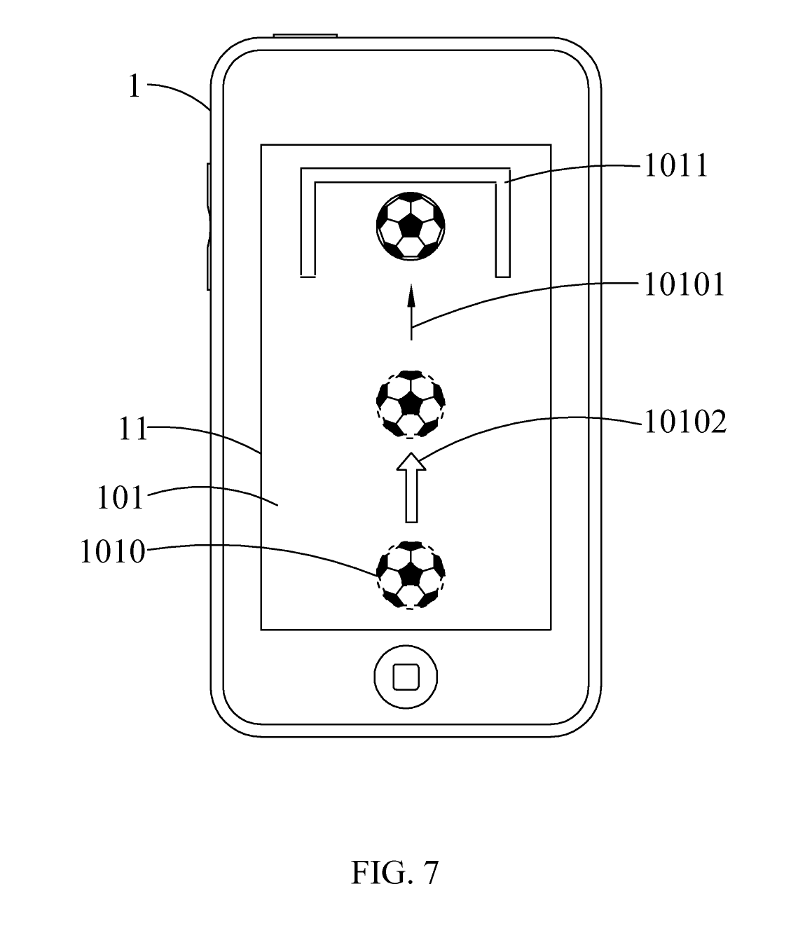

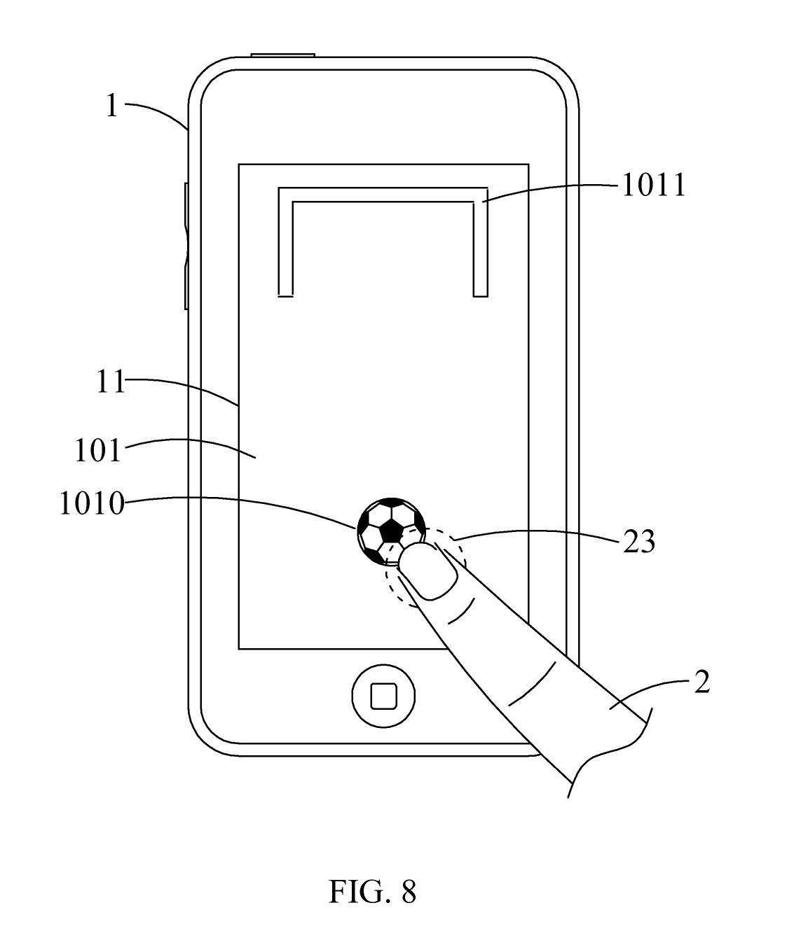

Please refer to FIG. 6 through FIG. 8. FIG. 6 through FIG. 8 are a first schematic view, a second schematic view and a third schematic view of a second embodiment of the touch controlled screen apparatus according to the present invention, and please refer to FIG. 1 through FIG. 5 together. As shown in FIGs, each of elements of the touch controlled screen apparatus of this embodiment is similar to corresponding element of the touch controlled screen apparatus described in the first embodiment, so description in detail is omitted herein. However, it is worth mentioning that the processing module 12 determines a movement direction 10101 of the active object 1010 according to the operation signal 121 corresponding to the touch signal 110 while the touch controlled display module 11 generates the touch signal 110 upon receipt of the touch contact 21.

When the touch contact 21 is removed by the touch controlled display module 11, the processing module 12 controls the active object 1010 to move along the movement direction 10101, and the processing module 12 determines that the operation signal 121 matches the predetermined condition while the active object 1010 is moved to the passive object 1011.

In short, the touch controlled display module 11 detects the touch contact 21 upon user's touch action on the active object 1010 on the graphic interface 101 displayed by the touch controlled display module 11, and generates the touch signal 110 to be transmitted to the processing module 12 according to the touch contact 21. The processing module 12 generates the operation signal 121 according to touch signal 110, and determines the movement direction 10101 of the active object 1010 according to the operation signal 121. For example, while the user 2 touches the active object 1010 on the graphic interface 101 by figure and rotates in clockwise or counterclockwise direction, the clockwise or counterclockwise operation signal 121 is generated upon the touch signal 110 and then the processing module 12 controls the orientation 10102 of the active object 101 to rotate clockwise or counterclockwise on the graphic interface 101 according to the operation signal 121. The orientation 10102 will be the movement direction 10101 of the active object 1010. And, user 2 also can touch the active object 1010 by finger and slide toward a right direction, and the processing module 12 controls the orientation 10102 of the active object 1010 to move right on the graphic interface 101 according to the operation signal 121 corresponding to the user's action, and the orientation 10102 is used to be the movement direction 10101 of the active object 1010.

Next, user 2 stops touching the active object 1010, for example, user's finger or the stylus is moved away from the touch controlled display module. At the time, the processing module 12 determines that the touch contact 21 is removed by the touch controlled display module 11, therefore, the processing module 12 controls the active object 1010 to move along the movement direction 10101, and determines whether the active object 1010 is moved to where the passive object 1011 is located. If yes, the processing module 12 determines that the operation signal 121 matches the predetermined condition and then closes the predetermined icon program 100, so that the touch controlled screen apparatus 1 releases the first status and is changed to the second status from the first status. If no, the processing module 12 determines that the operation signal 121 corresponding to user's operation does not match the predetermined condition, and then perform reset.

In addition, when the processing module 12 according to the present invention does not receive the touch signal 110 in a predetermined period and a count of resetting the predetermined period exceed a predetermined number, the processing module 12 closes the predetermined icon program 100.

In other words, when the processing module 12 receives the execution signal 120, the processing module 12 controls the touch controlled display module 11 to display the graphic interface 101, and determines whether the touch signal 110 generated upon user's action is received in the predetermined period, such as 30 seconds. If determining that touch signal 110 is not received, the processing module 12 resets the predetermined period and again determines whether the touch signal 110 is received. When the processing module 12 does not receive the touch signal 110 and the count of resetting the predetermined period exceeds the predetermined number set by the processing module 12, such as 5 times, the processing module 12 closes the predetermined icon program 100 and controls the touch controlled display module 11 to stop displaying the graphic interface 101, and then makes the touch controlled screen apparatus 1 enter the lock status. Such method may prevent the execution signal 120 from being generated due to user's inadvertent touch, and prevent the touch controlled screen apparatus 1 from continuously executing the predetermined icon program 100 and unnecessary power consumption.

It should be noted that the processing module 12 of the touch controlled screen apparatus 1 according to the present invention also may perform a detection program to determine whether the touch signal 110 generated by user 2 is received, so the embodiment is not limited by the usage of predetermined period.

Moreover, when the processing module 12 determines that an initial touch position of touch contact 21 or touch track 20 is located at the active object 1010 or near the active object 1010, the processing module 12 can determine the movement direction 10101 or the movement track 10100 of the active object 1010 according to the operation signal 121.

Specifically, when determining that the touch signal 110 generated by user 2 is received, the processing module 12 determines whether the initial touch position 23 of touch contact 21 or touch track 20 is located at or near the active object 1010. If yes, the processing module 12 performs the operations described in first embodiment and the second embodiment according to the touch signal 110 by user 2. If no, the processing module 12 continuously determines whether the initial touch position 23 of user's next touch is located at or near the active object 1010.

It is worth mentioning that, if the processing module 12 of the touch controlled screen apparatus 1 according to the present invention determines that the initial touch position 23 of the touch contact 21 is located at or near the active object 1010, the touch controlled display module 11 according to the present invention also may display an auxiliary active object, for example, the active object 1010 is a football and the auxiliary active object can be a player. The operations for the touch track 20 are similar to those for touch contact 21.

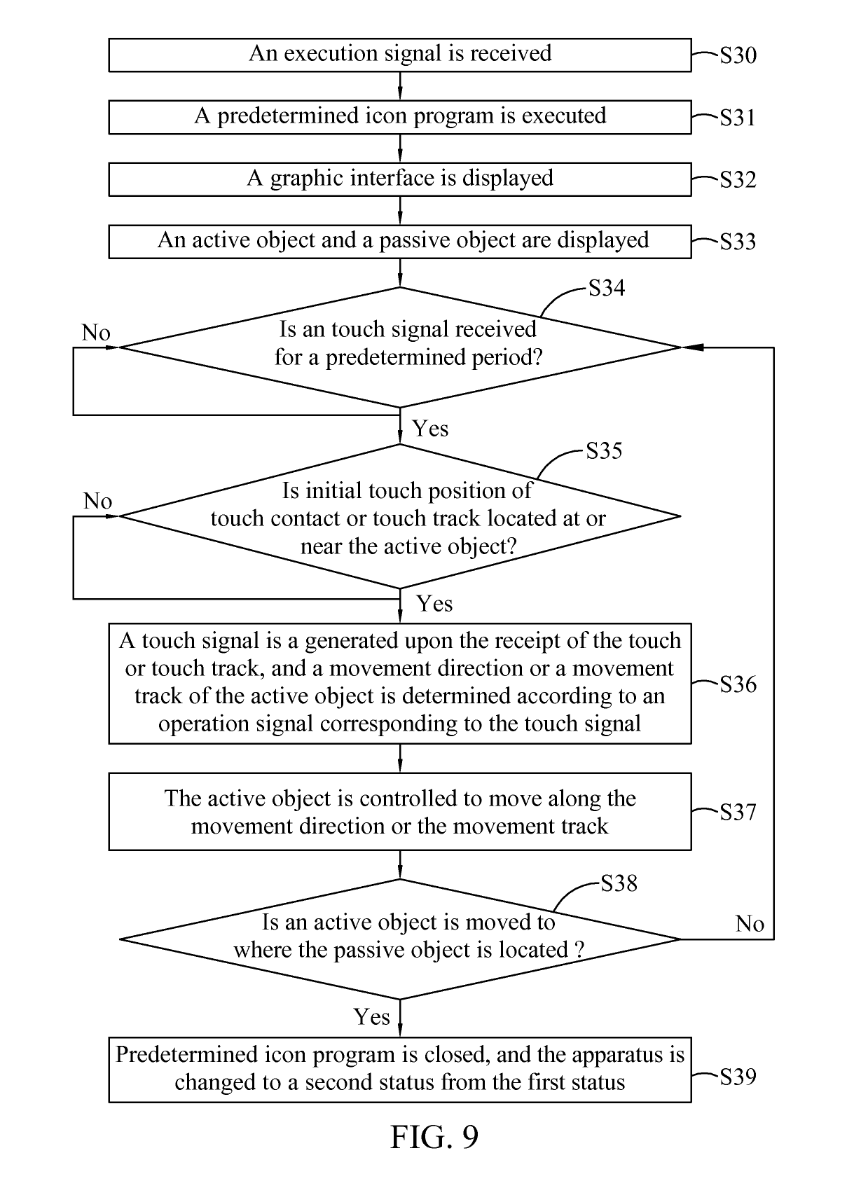

Please refer to FIG. 9, FIG. 9 is a flow diagram of unlock method of the touch controlled screen apparatus according to the present invention. Please refer to FIG. 1 through FIG. 8 together. As shown in FIG. 9, the unlock method of the touch controlled screen apparatus according to the present invention comprises following steps:

(S30): An execution signal is received;

(S31): A predetermined icon program is executed;

(S32): A graphic interface is displayed;

(S33): An active object and an passive object are displayed;

(S34): It is determined whether a touch signal is received for a predetermined period. If yes, step S35 is performed. if no, the predetermined period is reset and the said determination is performed again;

(S35): It is determined whether the initial touch position of touch or touch track is located at or near the active object. If yes, step S36 is performed. If no, reset is performed, and then it is again determined whether the touch position of touch or touch track is located at or near the active object in step S35;

(S36): A touch signal is generated upon the receipt of the touch or touch track, and a movement direction or a movement track of the active object is determined according to an operation signal corresponding to the touch signal;

(S37): The active object is controlled to move along the movement direction or the movement track;

(S38): It is determined whether the active object is moved to where the passive object is located. If yes, step S39 is performed. If no, step S34 is performed;

(S39): The predetermined icon program is closed, and the touch controlled screen apparatus is changed to a second status from the first status.

While embodiments of the present invention have been described in connection with certain exemplary embodiments, the purpose is to convey the scope of the present invention to those of skill in the art for practice, and it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch controlled screen apparatus, comprising:
a storage module, storing at least one predetermined icon program, and the at least one predetermined icon program having a graphic interface;
a touch controlled display module, displaying the graphic interface, and detecting a touch contact or a touch track to generate a touch signal; and
a processing module, electrically connected to the storage module and the touch controlled display module, and receiving the touch signal, wherein when the processing module receives an execution signal at a first status of the touch controlled screen apparatus, the processing module executes the at least one predetermined icon program, and generates an operation signal according to touch signal corresponding to operation on the graphic interface, when the processing module determines that the operation signal matches a predetermined condition, the processing module closes the at least one predetermined icon program, and control the touch controlled screen apparatus to change to a second status from the first status.

2. The touch controlled screen apparatus of claim 1, wherein the graphic interface comprises an active object, and when the touch signal corresponding to the touch track is generated, the processing module determines a movement track of the active object according to the operation signal corresponding to the touch signal.

3. The touch controlled screen apparatus of claim 2, wherein the graphic interface further comprises a passive object, the processing module controls the active object to move along the movement track, and the processing module determines that the operation signal matches the predetermined condition when the active object is moved to the passive object.

4. The touch controlled screen apparatus of claim 1, wherein the graphic interface comprises an active object, and when the touch signal corresponding to the touch is generated, the processing module determines a movement direction of the active object according to the operation signal corresponding to the touch signal.

5. The touch controlled screen apparatus of claim 4, wherein the graphic interface further comprises a passive object, when the touch is removed by the touch controlled display module, the processing module controls the active object to move along the movement direction, and when the active object is moved to the passive object, the processing module determines that the operation signal matches the predetermined condition.

6. The touch controlled screen apparatus of claim 3, wherein the passive object has at least two target areas, when the active object is moved to one of at least two target areas corresponding to a predetermined area, the processing module determines that the operation signal matches the predetermined condition.

7. The touch controlled screen apparatus of claim 5, wherein the passive object has at least two target areas, when the active object is moved to one of at least two target areas corresponding to a predetermined area, the processing module determines that the operation signal matches the predetermined condition.

8. The touch controlled screen apparatus of claim 6, wherein each of the at least two target areas respectively has a predetermined score, when the active object is moved to one of the at least two target areas and the processing module determines that the predetermined score exceeds a threshold, the processing module determines that the operation signal matches the predetermined condition.

9. The touch controlled screen apparatus of claim 2, wherein when the processing module does not receive the touch signal for a predetermined period and a count of resetting the predetermined period exceeds a predetermined number, the processing module closes the at least one predetermined icon program.

10. The touch controlled screen apparatus of claim 4, wherein when the processing module does not receive the touch signal for a predetermined period and a count of resetting the predetermined period exceeds a predetermined number, the processing module closes the at least one predetermined icon program.

11. The touch controlled screen apparatus of claim 2, wherein when the processing module determines that an initial touch position of the touch or touch track is located at or near the active object; the processing module determines the movement direction or the movement track of the active object according to the operation signal.

12. The touch controlled screen apparatus of claim 4, wherein when the processing module determines that an initial touch position of the touch or touch track is located at or near the active object; the processing module determines the movement direction or the movement track of the active object according to the operation signal.
